(19) United States
(12) Patent Application Publication
(10) Pub. No.: US 2025/0371431 A1
(43) Pub. Date: Dec. 4, 2025

(54) SYSTEM, METHOD, AND PROGRAM FOR PERFORMANCE EVALUATION OR TRAIN OF A CHART DE-RENDERING ARTIFICIAL INTELLIGENCE MODEL USING DATA SET INCLUDING CONSTRUCTED CHART INFORMATION

(71) Applicant: LG MANAGEMENT DEVELOPMENT INSTITUTE CO., LTD., Seoul (KR)

(72) Inventors: Kwangrok RYOO, Seoul (KR); Seungjun LEE, Gyeonggi-do (KR); Soonyoung LEE, Seoul (KR)

(21) Appl. No.: 19/299,112

(22) Filed: Aug. 13, 2025

Related U.S. Application Data
(63) Continuation of application No. PCT/KR2025/001492, filed on Jan. 24, 2025.

(30) Foreign Application Priority Data
Jan. 25, 2024 (KR) 10-2024-0011843

(51) Int. Cl. G06N 20/00

(52) U.S. Cl. CPC G06N 20/00

(57) ABSTRACT

A system, method, and program evaluate the performance of an artificial intelligence (AI) model that de-renders a chart or for training the AI model by constructing a data set including chart information. The system includes memory storing a data set generation model and an AI model, and a processor configured to execute or train the AI model and execute a performance evaluation model. The data set generation model stores line information, which is information about a line of a chart, and meta information, which is information about meta data, as ground truth (GT), stores an image formed using the GT as a chart image, and outputs the GT and the chart image as a data set, and the AI model receives the chart image stored in the data set as input and outputs a data format in which information of the chart is predicted.

### CROSS-REFERENCE TO RELATED APPLICATIONS

This application is a continuation of International Application No. PCT/KR2025/001492, filed on Jan. 24, 2025, which claims priority from and the benefit of Korean Patent Application No. 10-2024-0011843, filed on Jan. 25, 2024, which are all hereby incorporated by reference in their entireties.

### TECHNICAL FIELD

The present disclosure generally relates to a system, method, and computer program for evaluating the performance of a chart de-rendering model or training the chart de-rendering model by constructing a data set including chart information, and more particularly, some embodiments of the present disclosure relate to a system, method, and computer program for evaluating the performance of an artificial intelligence model that de-renders a chart or training the artificial intelligence model by constructing a data set including chart information.

### RELATED ART

Chart de-rendering may refer to a process opposite to chart rendering. For example, the chart de-rendering may include an operation extracting key information by analyzing and grouping visual patterns or information of a chart, and extracting information about the data (for example, numerical values, groups, etc.), information about chart layout, etc. from the key information.

For the chart de-rendering, a data set composed of a chart image including text, lines, etc., and ground truth (GT) including information about the chart, is inputted into an artificial intelligence (AI) model. The data set may need to be refined so that the AI model can recognize the data set and may need to include various styles of data so that the AI model can be evaluated or trained from multiple perspectives.

As a conventional method for constructing the data set, a method of collecting data by crawling a specific website or the like (e.g., PlotQA: Reasoning over Scientific Plots, Nitesh Methani et al., 2020) has been used.

The conventional method may have a limitation in the amount of data included in the data set, and often only data written in a specific style is collected, so there is a problem of a lack of diversity of the collected data.

Furthermore, the chart de-rendering AI model recognizes not only numerical information included in the data but also meta information. However, the meta information (e.g., names of an X-axis and a Y-axis, names of entity groups recorded in a legend, etc.) is often not properly included in the data collected by crawling.

In addition, in order to more accurately evaluate or train the AI model, a method of classifying chart images drawn in a similar style into an experimental group and a control group and comparing the results may be used. However, the conventional data set construction method may have difficulty in collecting chart images of a similar style, and therefore may not use the comparison method as described above.

(Related Art Document) PlotQA: Reasoning over Scientific Plots, Nitesh Methani et al., 2020.

### SUMMARY

An object of some embodiments of the present disclosure is directed to providing a system, method, and computer program for evaluating the performance of an artificial intelligence model that de-renders a chart or training the artificial intelligence model by constructing a large amount of data sets including chart information.

Objects of the present disclosure are not limited to the above-described object, and other objects that are not mentioned will be clearly understood by those skilled in the art from the following description.

A system for implementing a chart de-rendering model according to certain embodiments of the present disclosure includes at least one processor, and at least one memory storing a command or information that cause the at least one processor to perform an operation, wherein the operation performed by the command includes storing, by a data set generation model, line information, which is information about at least one line of a chart, and meta information, which is information about meta data, as ground truth (GT), storing an image formed using the GT as a chart image, and outputting the GT and the chart image as a data set, inputting the chart image stored in the data set into an AI model and outputting a data format in which information of the chart is predicted, and inputting the data format into a performance evaluation model and outputting a performance evaluation result for the AI model by comparing information of the data format with the GT stored in the data set, wherein a value applied to each parameter included in the line information and each parameter included in the meta information is selected from among predetermined values. The parameters included in the line information may include an X-axis value of a chart line, a function, a coefficient of the function, a color or a shape of a line or a point, etc. and the parameters included in the meta information may include a chart title, an X-axis name, a Y-axis name, a legend, etc. Furthermore, the data format output from the AI model may be used to evaluate the performance of the AI model or to train the AI model.

The system may further include inputting the data format output from the AI model into the performance evaluation model and outputting the performance evaluation result for the AI model by comparing the information of the data format with the GT stored in the data set.

The system may further include training, by the AI model, the AI model using a comparison result by comparing the information of the data format output from the AI model with the GT stored in the data set.

In the system, the parameter included in the line information may be configured to include an X-axis value of a chart line, a function, and a coefficient of the function.

In the system, the data set may include a first data set and a second data set, and a difference between a coefficient of the function included in the second data set and a coefficient of the function included in the first data set may be less than a preset value.

In the system, the maximum value of values of the function may be greater than a preset maximum function value, and the minimum value of values of the function may be less than a preset minimum function value.

In the system, the parameter included in the line information may be configured to include a color or a shape of a line or a point.

In the system, the parameter included in the meta information may be configured to include a chart title, an X-axis name, a Y-axis name, and a legend.

In the system, a value applied to each parameter may be selected based on a predetermined probability for each of the predetermined values.

A method for implementing a chart de-rendering model according to some embodiments of the present disclosure includes storing, by a data set generation model, line information, which is information about at least one line of a chart, and meta information, which is information about meta data, as ground truth (GT), storing an image formed using the GT as a chart image, and outputting the GT and the chart image as a data set, inputting the chart image stored in the data set into an AI model and outputting a data format in which information of the chart is predicted, and inputting the data format into a performance evaluation model and outputting a performance evaluation result for the AI model by comparing information of the data format with the GT stored in the data set, wherein a value applied to each parameter included in the line information and each parameter included in the meta information is selected from among predetermined values.

The method may further include inputting the data format output from the AI model into the performance evaluation model and outputting the performance evaluation result for the AI model by comparing the information of the data format with the GT stored in the data set.

The method may further include comparing, by the AI model, the information of the data format output from the AI model with the GT stored in the data set, and training the AI model using a comparison result.

In the method, the parameter included in the line information may be configured to include an X-axis value of a chart line, a function, and a coefficient of the function.

In the method, the data set may include a first data set and a second data set, and a difference between a coefficient of the function included in the second data set and a coefficient of the function included in the first data set may be less than a preset value.

In the method, the maximum value of values of the function may be greater than a preset maximum function value, and the minimum value of values of the function may be less than a preset minimum function value.

In the method, the parameter included in the line information may be configured to include a color or a shape of a line or a point.

In the method, the parameter included in the meta information may be configured to include a chart title, an X-axis name, a Y-axis name, and a legend.

In the method, a value applied to each parameter may be selected based on a predetermined probability for each of the predetermined values.

A program according to still another aspect of the present invention may be stored in a computer-readable recording medium to implement a chart de-rendering model according to certain embodiments of the present disclosure, in conjunction with a computer.

According to some embodiments of the present disclosure, a data set that fully includes information about a chart can be derived, a large number of chart images formed in various styles can be generated with high degrees of freedom using parameters of line information and meta information, and by using a method of appropriately selecting the parameters of line information and meta information, output results can be classified into an experimental group and a control group, thereby more accurately evaluating or training an AI model.

In addition, according to certain embodiments of the present disclosure, a large amount of data sets including charts of a similar shape can be generated in order to evaluate whether an AI model can accurately recognize a chart of a specific shape, or to train the AI model to accurately recognize a chart of a specific shape.

In addition, some embodiments of the present disclosure can prevent the shape of a chart included in data set from being distorted so that an AI model can be accurately evaluated or efficiently trained.

In addition, according to certain embodiments of the present disclosure, a large amount of data sets including charts having various lines or points can be output so that an AI model can be accurately evaluated or efficiently trained.

In addition, according to some embodiments of the present disclosure, a large amount of data sets including complete meta information can be output to accurately evaluate whether an AI model accurately recognizes meta information included in a chart image or to train the AI model to accurately recognize meta information included in the chart image.

Effects of the present disclosure are not limited to the above-described effects, and other effects that are not mentioned will be clearly understood by those skilled in the art from the following description.

### BRIEF DESCRIPTION OF DRAWINGS

FIG. 1 is a schematic diagram of a system for implementing a method for evaluating the performance of an artificial intelligence model that de-renders a chart or training the artificial intelligence model by constructing a data set including chart information, according to one embodiment of the present disclosure.

FIG. 2 is a block diagram for a device for evaluating the performance of an artificial intelligence model that de-renders a chart or training the artificial intelligence model by constructing a data set including chart information, according to one embodiment of the present disclosure.

FIG. 3 is a block diagram for explaining a method for evaluating the performance of an artificial intelligence model that de-renders a chart or training the artificial intelligence model by constructing a data set including chart information, according to embodiments of the present disclosure.

FIGS. 4A to 6B are examples of chart images output from a data set generation model, according to embodiments of the present disclosure.

### DETAILED DESCRIPTION OF EMBODIMENTS

The following embodiments are provided as examples so that the spirit of the present disclosure can be sufficiently conveyed to those skilled in the art to which the present invention pertains. Therefore, the present disclosure is not limited to the embodiments described below and may be specified in other forms.

The same reference numerals refer to the same components throughout the present invention. The present invention does not describe all elements of the embodiments, and common content in the art to which the present invention pertains or content that overlaps between the embodiments will be is omitted. Terms “unit,” “module,” “member,” and “block” used in the specification may be implemented as software or hardware, and according to the embodiments, a plurality of “units,” “modules,” “members,” and “blocks” may be implemented as one component, or one “unit,” “module,” “member,” and “block” may also include a plurality of components.

Throughout the specification, when a first component is described as being “connected” to a second component, this includes not only a case in which the first component is directly connected to the second component but also a case in which the first component is indirectly connected to the second component, and the indirect connection includes connection through a wireless communication network.

In addition, when a certain portion is described as “including” a certain component, it means further including other components rather than precluding other components unless specifically stated otherwise.

Throughout the present specification, when a first member is described as being positioned “on” a second member, this includes both a case in which the first member is in contact with the second member and a case in which a third member is present between the two members.

Terms such as first and second are used to distinguish one component from another, and the components are not limited by the above-described terms.

A singular expression includes plural expressions unless the context clearly dictates otherwise.

In each operation, identification symbols are used for convenience of explanation, and the identification symbols do not describe the sequence of each operation, and each operation may be performed in a different sequence from the specified sequence unless a specific sequence is clearly described in context.

A system for evaluating the performance of an artificial intelligence model that de-renders a chart or training the artificial intelligence model by constructing a data set including chart information according to some embodiments of the present disclosure may include a device that may include all types of devices capable of performing computational processing and providing results to a user. For example, the system for evaluating the performance of the artificial intelligence model that de-renders the chart or training the artificial intelligence model by constructing the data set including the chart information according to an embodiment of the present disclosure may include at least one of a computer, a server device, and/or a portable terminal, or may be implemented in any one form having the same or similar functions thereof. However, the present disclosure is not limited thereto.

Here, the computer may include, for example, a notebook, a desktop, a laptop, a tablet personal computer (PC), a slate PC, etc., which are equipped with a web browser.

The server device may be a server that processes information in communication with an external device, and may include an application server, a computing server, a database server, a file server, a game server, a mail server, a proxy server, and a web server.

The portable terminal is, for example, a wireless communication device which can provide portability and mobility, and may include all kinds of handheld-based wireless communication devices such as a personal communication system (PCS), a global system for mobile communications (GSM), a personal digital cellular (PDC), a personal handyphone system (PHS), a personal digital assistant (PDA), international mobile telecommunication-2000 (IMT-2000), code division multiple access-2000 (CDMA-2000), w-code division multiple access (W-CDMA), a wireless broadband internet (WiBro) terminal, a smart phone, and wearable devices such as a watch, a ring, a bracelet, an anklet, a necklace, glasses, contact lenses, or a head-mounted device (HMD).

Hereinafter, embodiments of the present disclosure will be described in detail with reference to the accompanying drawings.

Some embodiments of the present disclosure relate to a system, method, and program for evaluating the performance of a chart de-rendering model or training the chart de-rendering model by constructing a data set including chart information, and more particularly, certain embodiments of the present disclosure may relate to a system, method, and program for evaluating the performance of an artificial intelligence model that de-renders a chart or training the artificial intelligence model by constructing a data set including chart information.

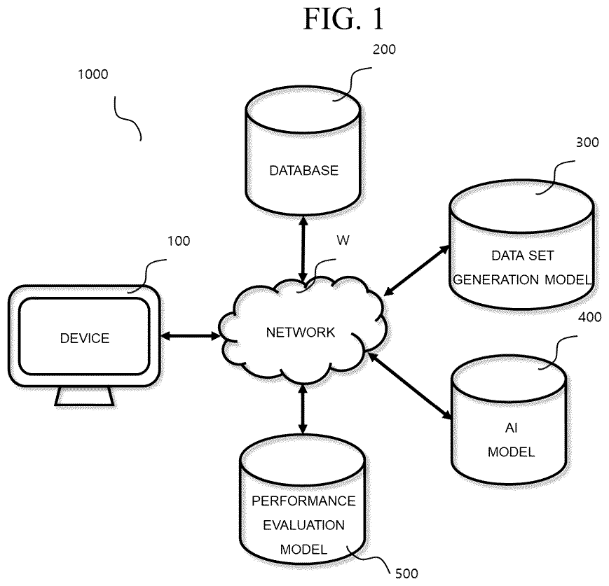

FIG. 1 is a schematic diagram of a system for evaluating the performance of a chart de-rendering model or training the chart de-rendering model by constructing a data set including chart information according to one embodiment of the present disclosure.

As shown in FIG. 1, a system 1000 may include a device 100, a database 200, a data set generation model 300, an artificial intelligence (AI) model 400, and a performance evaluation model 500.

The device 100, the database 200, the data set generation model 300, the AI model 400, and the performance evaluation model 500 included in the system 1000 may perform communication via a network W. Here, the network W may include a wired network and/or a wireless network. For example, the network may include various types of networks such as a local area network (LAN), a metropolitan area network (MAN), and a wide area network (WAN).

In addition, the network W may also include the well-known world wide web (WWW). However, the network W according to embodiments of the present invention is not limited to the above-listed networks and may include, at least in part, a well-known wireless data network, a well-known telephone network, or a well-known wired and wireless television network.

The device 100 may input a data set generated by the data set generation model 300 into the AI model 400, and the AI model 400 outputs information about a chart. Based on the output information about the chart, the performance evaluation model 500 may evaluate the performance of the AI model 400, and the AI model 400 may perform training.

The data set generation model 300 generates a data set 410 that is used for chart de-rendering through AI and inputs the data set 410 into the AI model 400. The data set 410 may be a data set which is generally the same as that used to train the AI model 400 or evaluate the performance of the AI model 400, but is not limited thereto. The data set 410 generated through the data set generation model 300 may comprise a chart image including text, lines, etc., ground truth (GT) including the information about the chart, and the like. The data set 410 includes a train set used to evaluate the accuracy of the AI model 400 through the results of chart de-rendering using artificial intelligence, a test set used to train (e.g., deep learning, etc.) the AI model 400 used for chart de-rendering, and the like.

A form of the chart included in the data set 410 may be, for example, but not limited to, a vertical/horizontal bar chart, a line chart, a pie chart, an area chart, a scatter chart, a radar chart, a histogram, and/or a waterfall chart. The form of the chart may be a single form or a combination of a plurality of forms. However, the chart used in the present disclosure is not limited thereto, and the chart may include any form of chart. In addition, the chart may include text information in addition to information (e.g., a line, a circle, etc.) that visualizes numerical values, etc., and specifically, may include annotation information of the chart, a legend or title of the chart, a name of each axis (e.g., X-axis, Y-axis, Z-axis, etc.), numerical values of raw data of points included in the chart (e.g., numerical values of X-axis and Y-axis of points included in the chart), etc.

The information about the chart output from the AI model 400 may be information that represents features of the chart and include meta information, data information, etc. The meta information may include names of X-axis and Y-axis, a name of an entity group recorded in the legend, etc. The data information may include numerical values of X-axis and/or Y-axis of each entity, etc.

The information about the chart output from the AI model 400 may be input into the performance evaluation model 500, and the performance evaluation model 500 evaluates the performance of the AI model 400 by comparing the output information about the chart with the GT included in the data set 410.

A performance evaluation result output from the performance evaluation model 500 may indicate how accurately the AI model 400 predicts the chart. For instance, the performance evaluation result may be represented as a score expressed in numerical form, a chart expressed in image form, and the like, but is not limited thereto.

In addition, the device 100 may compare the information about the chart output from the AI model 400 with the information about the chart stored in the data set 410, and the AI model 400 may perform training using the comparison result.

The database 200 may store various types of data (e.g., data sets) for training or evaluating the performance of the AI model 400. In addition, the database 200 may store the chart image, the information about the chart, information about a performance evaluation method, information about a data set generation method, and the like, and in various embodiments, may also store output data output by the AI model 400. However, the system 1000 may not include the database 200 when or after the training of the AI model 400 is completed.

FIG. 1 shows an exemplary embodiment in which the database 200 is implemented as a separate device from the device 100. In this case, the database 200 may be connected to the device 100 in a wired or wireless communication manner. However, this is only one embodiment, and the database 200 may also be included in the device 100 as one component of the device 100.

FIG. 1 shows an exemplary embodiment case in which the AI model 400 is not included in the device 100 (e.g., implemented in a cloud-based manner). However, the present disclosure is not limited thereto, and the AI model 400 may be comprised in the device 100 as one component of the device 100.

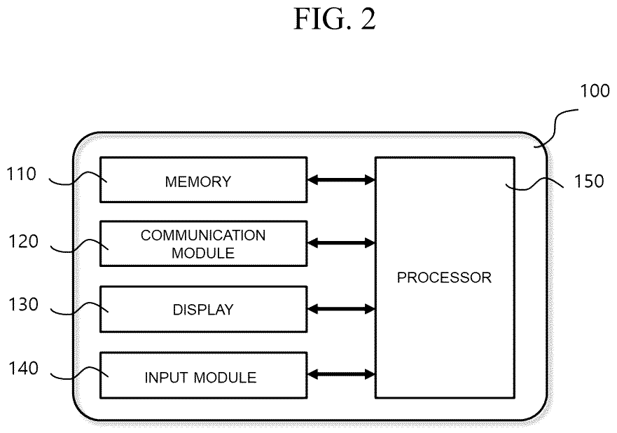

FIG. 2 is a block diagram for a device for evaluating the performance of an artificial intelligence model that de-renders a chart or training an artificial intelligence model by constructing a data set including chart information, according to one embodiment of the present invention.

As shown in FIG. 2, the device 100 may include a memory 110, a communication module or a communicator 120, a display 130, an input module 140, and one or more processors 150. However, the present disclosure is not limited thereto, and software and hardware components of the device 100 may be modified, added, or omitted depending on a necessary operation. In addition, the device 100 may be replaced with a system, and the device 100 may be implemented as a plurality of devices, and one or more components included in the device 100 may be included in at least one of the plurality of devices.

The memory 110 may store data supporting various functions of the device 100 and one or more programs for the operation of the processor 150, and store input and/or output data, a plurality of application programs or applications that are executed or driven on the device 100, data, command and the AI model for the operation of the device 100. One or more of the application programs may be downloaded from an external server via wireless communication.

For example, the memory 110 may include at least one type of storage medium among a flash memory type, a hard disk type, a solid state disk type (SSD type), a silicon disk drive type (SDD type), a multimedia card micro type, a card-type memory (e.g., an SD or XD memory), a random access memory (RAM), a static random access memory (SRAM), a read-only memory (ROM), an electrically erasable programmable ROM (EEPROM), a programmable ROM (PROM), a magnetic memory, a magnetic disk, and an optical disk.

In addition, the memory 110 may be separate from the device 100, and may include a database that is connected in a wired or wireless communication manner. The database 200 shown in FIG. 1 may be implemented as one component of the memory 110.

The communication module or communicator 120 may include one or more components that enable communication with an external device, and may include at least one of, for example, a broadcasting reception module, a wired communication module, a wireless communication module, a short-range communication module, or a position information module.

The wired communication module may include, for instance, but not limited to, not only various wired communication modules such as a local area network (LAN) module, a wide area network (WAN) module, and a value added network (VAN) module, but also various cable communication modules such as a universal serial bus (USB), a high definition multimedia interface (HDMI), a digital visual interface (DVI), a recommended standard 232 (RS-232), power line communication, and plain old telephone service (POTS).

In addition to the WiFi module and the wireless broadband (WiBro) module, the wireless communication module may include, for example, but not limited to, a wireless communication module for supporting various wireless communication methods such as global system for mobile communication (GSM), code division multiple access (CDMA), wideband CDMA (WCDMA), universal mobile telecommunications system (UMTS), time division multiple access (TDMA), long term evolution (LTE), 4G, 5G, or 6G.

The display 130 displays or outputs information or data that is processed in the device 100, data that is input or output through the AI model 400, etc. In addition, the display 130 may display execution screen information of an application program (e.g., an application) driven or executed on the device 100, or user interface (UI) or graphic user interface (GUI) information according to such execution screen information.

The input module 140 is configured to receive information from a user. When the user inputs information through the input module 140, the processor 150 may control the operation of the device 100 according to the input information.

The input module 140 may include, for example, but not limited to, a hardware physical key (e.g., a button located on at least one of a front surface, a back surface, and a side surface of the device 100, a dome switch, a jog wheel, a jog switch, etc.) and a software touch key. As an example, the touch key may include a virtual key, a soft key, or a visual key that is displayed on a touchscreen type of the display 130 through software processing or may be formed as the touch key located at a portion other than the touchscreen. Meanwhile, the virtual key or visual key may be implemented as various forms. For instance, the virtual key or visual key may be displayed on the touchscreen, and may be displayed in a form of, for example, a graphic, text, an icon, a video, or a combination thereof.

The processor 150 may comprise a memory configured to store data for an algorithm for controlling one or more operations (including training or execution of the AI model) of one or more components included in the device 100 or a program that reproduces the algorithm, and at least one processor configured to perform or executed the above-described operation using the data stored in the memory. In this case, the memory and the processor comprised in the processor 150 may each be implemented as separate chips or may be implemented as a single integrated chip.

In one embodiment, the system 1000 or the device 100 according to an embodiment of the present disclosure may include at least one processor. In an exemplary embodiment in which the system 1000 or the device 100 includes a plurality of processors, each of the plurality of processors may be included in different devices 100.

In addition, the processor 150 may control the operations of one or more components of the device 100 by combining one or more of the above-described components in order to implement various embodiments, which will be described below, on the device 100.

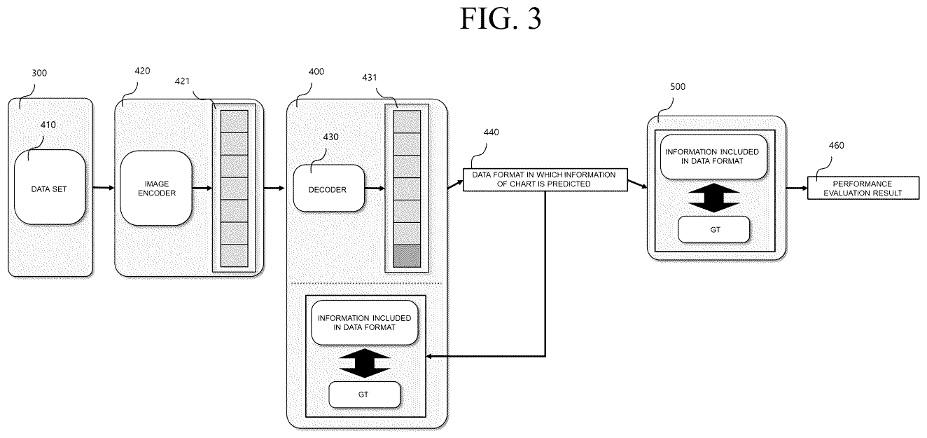

FIG. 3 is a block diagram for explaining a method for evaluating the performance of a chart de-rendering model or training the chart de-rendering model by constructing a data set including chart information, according to an embodiment of the present disclosure.

Referring to FIG. 3, the data set generation model 300 generates the data set 410 including chart image including text, lines, etc., ground truth (GT) including information about a chart, and the like. Here, the chart image includes, for instance, but not limited to, a title, an axis name, legend information, numerical values, and the like. A form of the chart image included in the data set 410 may be a vertical or horizontal bar chart, a line chart, a pie chart, an area chart, a scatter chart, a radar chart, a histogram, and/or a waterfall chart, but is not limited thereto. In addition, the form of the chart may be a single form or combination of a plurality of forms.

Here, the GT of the data set generated by the data set generation model 300 may include information about the chart, and includes line information, which is information about lines formed in the chart (e.g., X-axis values of a chart line, a function, a coefficient of the function, maximum and/or minimum function values, a color of a line or a point, a shape of a line or a point, etc.), and meta information, which is information (e.g., a chart title, an X-axis name, a Y-axis name, a legend, etc.) about meta data.

In this case, a value applied to each parameter included in the line information and each parameter included in the meta information are selected from among predetermined values.

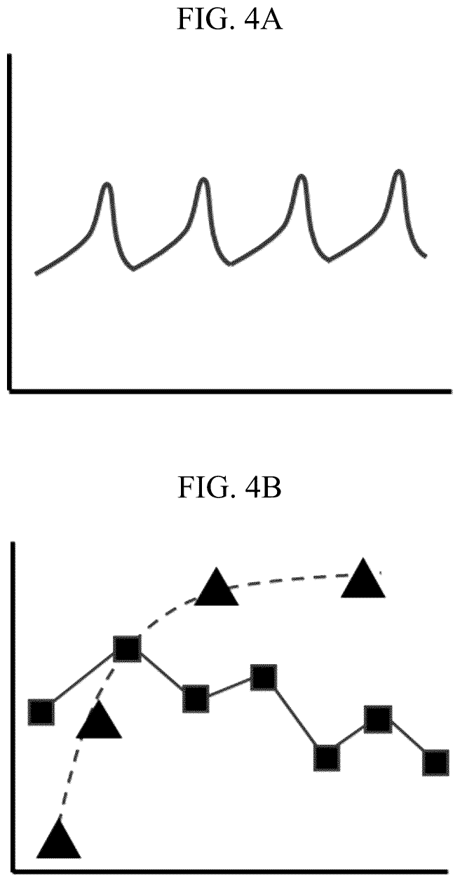

For example, among the parameters included in the line information, a “function” parameter may be selected as a sum of one or more functions from a category including a polynomial function, sinusoidal function, gaussian function, exponential function, logarithm function, pareto function, random function, etc. In particular, when a plurality of sinusoidal functions are used, all periodic functions can be represented by Fourier series. For instance, as shown in FIG. 4A, a periodic function can be represented by using the plurality of sinusoidal functions.

In addition, for example, by predetermining categories of colors or shapes of lines or points and allowing selection therefrom, as shown in FIG. 4B, a chart in which both a dotted line and a solid line are included, a chart in which both a line with triangular points and a line with quadrangular points are comprised, and the like may also be configured.

Therefore, certain embodiments of the present disclosure may derive a data set that fully includes information about a chart, generates a large number of chart images formed in various styles with high degrees of freedom using parameters of line information and meta information, classifies output results into an experimental group and a control group by using a method of appropriately selecting the parameters of the line information and the meta information, thereby more accurately evaluating or training an AI model.

Next, the data set 410 generated through the data set generation model 300 is input into an image encoder 420. The image encoder 420 may use a generally used encoder architecture and be configured to convert an input chart 410a into a first embedding 421 that may be processed by the AI model 400.

Next, the first embedding 421 output from the image encoder 420 is input into the AI model 400 including a decoder 430 configured to perform a decoding operation such as meta decoding, data decoding, and the like. The decoder 430 decodes the input first embedding 421 to extract the meta information (e.g., chart title, X-axis name, Y-axis name, legend), the data information (e.g., data point numerical values, etc.) of the chart, and the like, and outputs the meta information and the data information as a second embedding 431.

As such, the AI model 400 may output a data format 440 in which the information of the chart is predicted, that is, a data format including the meta information, the data information, and the like, from the output second embedding 431.

Next, the data format 440 output from the AI model 400 may be input into a chart de-rendering performance evaluation model 500. The chart de-rendering performance evaluation model 500 compares the information of the chart (e.g., chart title, X-axis name, Y-axis name, legend, data point numerical values, etc.) included in the data format 440 with the ground truth (GT) included in the data set 410, and derives a performance evaluation result 460 according to a predetermined method.

Meanwhile, the AI model 400 may perform training using the result of comparing the output data format 440 with the information about the chart stored in the data set 410. The training of the AI model 400 may be performed using hardware resources such as a central processing unit (CPU) and/or a graphics processing unit (GPU). The process of training the AI model 400 may be performed through a loss function that measures a difference between the output chart information and the GT stored in the data set 410. The loss function may vary depending on the type of task performed by the AI model 400 or the characteristics of the AI model 400 itself. Mean squared error (MSE), cross-entropy loss, and the like may be used as the loss function, but the present disclosure is not limited thereto. Since the AI model 400 may perform better predictions when the training is conducted to minimize the computed loss, the AI model 400 may be optimized by adjusting the weights of the AI model 400 in a direction that minimizes the computed loss. This optimization process may be performed using a backpropagation algorithm.

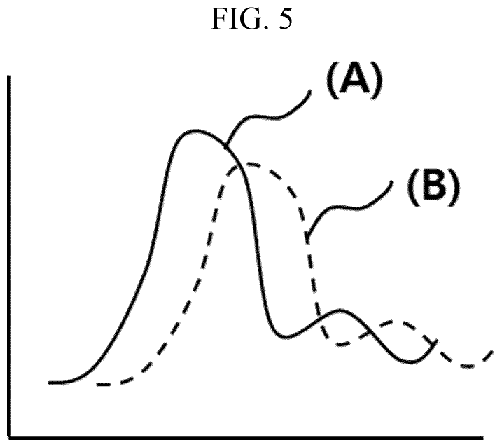

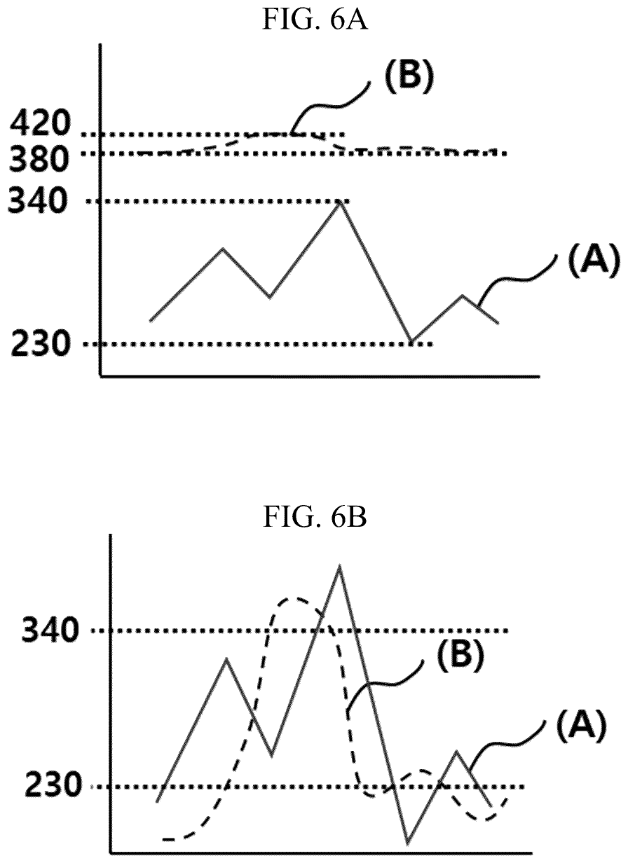

Hereinafter, the parameters included in the line information and the meta information used in the data set generation model 300 will be described in detail with reference to FIGS. 5 and 6.

First, in order to evaluate whether the AI model 400 accurately recognizes a chart of a specific shape, or to train the AI model 400 to accurately recognize a chart of a specific shape, an operation for repeatedly inputting chart images of a similar shape into the AI model 400 may be performed. To this end, the parameters of the line information may include X-axis values of a chart line, a function, and a coefficient of the function, and the like, and the data set generation model 300 may be configured to output a plurality of data sets 410 in which the “function” parameter is kept identical and only the “coefficient of the function” parameter differs by less than a preset value. As such, the plurality of data sets 410 in which the “function” parameter is identical and only the “coefficient of the function” slightly differs represent similar but not exactly matching shapes of the chart lines. For example, as shown in FIG. 5, since charts (A) and (B) have identical “function,” they may show similar shapes. However, since charts (A) and (B) have different “coefficients of the function”, they may show shapes that do not exactly match.

Therefore, according to an embodiment of the present disclosure, a large amount of data sets including charts of a similar shape can be generated in order to evaluate whether an AI model can accurately recognize a chart of a specific shape, or to train the AI model to accurately recognize a chart of a specific shape.

Meanwhile, when a range of values of the function included in the data set occupies a small proportion of the entire Y values of the chart, the shape of the line may not be clearly shown. For example, referring to FIG. 6, because function values of line (A) are distributed from 230 to 340, and function values of line (B) are distributed from 380 to 420, the function values of line (B) occupy a smaller proportion of the entire Y values compared to the function values of line (A). As a result, line (B) is shown compressed compared to line (A), thereby causing its shape to be distorted. To solve this problem, it may be configured so that the maximum value of the function of the line is greater than a preset maximum function value, and the minimum value of the function of the line is less than a preset minimum function value. For example, referring to FIG. 6, since the minimum and maximum function values of lines (A) and (B) are out of the range from 230 to 340 when the preset minimum function value is set to 230 and the preset maximum function value is set to 340, lines (A) and (B) are not shown in excessively compressed shapes. That is, since the function values of the chart lines may be more widely distributed than a certain range of the Y values, it is possible to prevent the phenomenon that a line is distorted in a compressed shape when the function values of the chart occupy a small proportion of the entire Y values of the chart.

Therefore, some embodiments of the present disclosure can prevent the shape of the chart included in the data set from being distorted so that the AI model can be accurately evaluated or efficiently trained.

Meanwhile, the line included in the chart may be formed as a dotted line or a straight line, and the color thereof may vary. In addition, a shape of the point represented on the line may be represented in various shapes such as a circle, quadrangle, triangle, etc. In order for the data set 410 including various charts to be output and input to the AI model, the parameters included in the line information of the data set may include a color or a shape of a line or a point.

Therefore, according to certain embodiments of the present disclosure, a large amount of data sets including charts having various lines or points can be output so that the AI model can be accurately evaluated or efficiently trained.

Meanwhile, the AI model may recognize not only the numerical information included in the date but also the meta information from the input chart image. In order to evaluate or train the AI model, it is necessary to input a large amount of data sets fully including the meta information (e.g., the names of the X-axis and Y-axis, the names of entity groups recorded in the legend, etc.) about the chart into the AI model. To this end, the data generation model 300 stores the meta information about the chart in addition to the line information as the GT in the data set 410. Here, the parameters included in the meta information may include a chart title, an X-axis name, a Y-axis name, and a legend, etc., and a value applied to each parameter of the meta information may be selected from among predetermined values. For example, among the parameters of the meta information, a value used for the X-axis name is predetermined as population, year, blood collection amount, blood sugar, fiscal year, etc., and a specific value is selected and reflected through a data generation model.

Therefore, according to some embodiments of the present disclosure, a large amount of data sets including complete meta information can be output to evaluate whether the AI model accurately recognizes the meta information included in the chart image or to train the AI model to accurately recognize the meta information included in the chart image.

Meanwhile, it may be necessary to intensively evaluate the recognition performance of the AI model for a chart having a specific parameter or to intensively train the AI model to improve its recognition performance for the chart having the specific parameter. In this case, it is necessary to intensively output charts having the specific parameter from the data set generation model 300 and input the charts into the AI model. To this end, a value applied to each parameter used in the data set generation model 300 may be selected from among predetermined values, and may be selected based on a certain probability for each predetermined value. For example, regarding the “function” among the parameter values, when there is a need to intensively output “gaussian function,” by assigning a higher probability to “gaussian function” compared to other “function” values (e.g., polynomial function, exponential function, logarithm function, etc.), the data set may be configured to include a large number of charts related to the “gaussian function”.

Therefore, according to certain embodiments of the present disclosure, a large number of chart images of various styles can be generated with high degrees of freedom, and in particular, a necessary data set can be intensively generated.

Meanwhile, a method for evaluating the performance of a chart de-rendering model or training the chart de-rendering model by constructing a data set including chart information, according to embodiments of the present invention, may be implemented by the system described with reference to FIG. 1.

AI models according to some embodiments of the present disclosure may be controlled, executed, trained, driven, etc. by one or more processors, and accordingly, at least one of tasks of executing, training, and driving AI models may be performed by at least one processor. In addition, the AI models may be stored in memory, and feature data according to certain embodiments of the present disclosure may also be stored in memory.

Meanwhile, disclosed embodiments may be implemented in the form of a recording medium in which computer-executable commands are stored. The commands may be stored in the form of program code, and when executed by the processor, program modules may be generated to perform operations of the disclosed embodiments. The recording medium may be implemented as a computer-readable recording medium.

The computer-readable recording medium includes all types of recording media in which computer-decodable commands are stored. For example, there may be a read only memory (ROM), a random access memory (RAM), a magnetic tape, a magnetic disk, a flash memory, an optical data storage device, and the like.

As described above, the disclosed embodiments have been described with reference to the accompanying drawings. Those skilled in the art to which the present disclosure pertains will understand that the present disclosure may be implemented in different forms from the disclosed embodiments without departing from the technical spirit or essential features of the present disclosure. The disclosed embodiments are illustrative and should not be construed as being limited.

What is claimed is:

1. A system comprising:
one or more processors; and
memory configured to store instructions that, when executed by the one or more processors, cause the system to perform operations comprising:
by a data set generation model, storing line information, which is information associated with at least one line of a chart, and meta information, which is information associated with meta data, as ground truth (GT), storing an image formed using the GT as a chart image, and outputting the GT and the chart image as a data set;
inputting the chart image stored in the data set into an artificial intelligence (AI) model and, by the AI model, outputting a data format, in which information of the chart is predicted, based on the input chart image; and
inputting the data format into a performance evaluation model and, by the performance evaluation model, outputting a performance evaluation result for the AI model by comparing information of the data format with the GT stored in the data set,
wherein a value applied to each parameter included in the line information and each parameter included in the meta information is selected from among predetermined values.

2. The system of claim 1, wherein the inputting of the data format into the performance evaluation model comprises inputting the data format output from the AI model into the performance evaluation model.

3. The system of claim 1, further comprising
training the AI model by comparing, by the AI model, the information of the data format output from the AI model with the GT stored in the data set.

4. The system of claim 1, wherein the each parameter included in the line information is configured to include a first-axis value of a chart line, a function, and a coefficient of the function.

5. The system of claim 4, wherein:
the data set includes a first data set and a second data set, and
a difference between a coefficient of a function included in the second data set and a coefficient of a function included in the first data set is less than a preset value.

6. The system of claim 4, wherein a maximum value of the function is greater than a preset maximum function value, and a minimum value of the function is less than a preset minimum function value.

7. The system of claim 1, wherein the each parameter included in the line information is configured to include a color or a shape of a line or a point.

8. The system of claim 1, wherein the each parameter included in the meta information is configured to include a chart title, a first-axis name, a second-axis name, and a legend.

9. The system of claim 2, wherein the value applied to the each parameter included in the line information and the each parameter included in the meta information is selected based on a predetermined probability for each of the predetermined values.

10. A computerized method comprising:
by a data set generation model, storing line information, which is information associated with at least one line of a chart, and meta information, which is information associated with meta data, as ground truth (GT), storing an image formed using the GT as a chart image, and outputting the GT and the chart image as a data set;
inputting the chart image stored in the data set into an artificial intelligence (AI) model and, by the AI model, outputting a data format in which information of the chart is predicted, based on the input chart image; and
inputting the data format into a performance evaluation model and, by the performance evaluation model, outputting a performance evaluation result for the AI model by comparing information of the data format with the GT stored in the data set,
wherein a value applied to each parameter included in the line information and each parameter included in the meta information is selected from among predetermined values.

11. The computerized method of claim 10, wherein the inputting of the data format into the performance evaluation model comprises inputting the data format output from the AI model into the performance evaluation model.

12. The computerized method of claim 10, further comprising
training the AI model by comparing, by the AI model, the information of the data format output from the AI model with the GT stored in the data set.

13. The computerized method of claim 10, wherein the each parameter included in the line information is configured to include a first-axis value of a chart line, a function, and a coefficient of the function.

14. The computerized method of claim 13, wherein:
the data set includes a first data set and a second data set, and
a difference between a coefficient of a function included in the second data set and a coefficient of a function included in the first data set is less than a preset value.

15. The computerized method of claim 13, wherein a maximum value of the function is greater than a preset maximum function value, and a minimum value of the function is less than a preset minimum function value.

16. The computerized method of claim 10, wherein the each parameter included in the line information is configured to include a color or a shape of a line or a point.

17. The computerized method of claim 10, wherein the each parameter included in the meta information is configured to include a chart title, a first-axis name, a second-axis name, and a legend.

18. The computerized method of claim 13, wherein the value applied to the each parameter included in the line information and the each parameter included in the meta information is selected based on a predetermined probability for each of the predetermined values.

19. A non-transitory computer-readable recording medium having instructions that, when executed by one or more processors, cause the one or more processors to:
by a data set generation model, store line information, which is information associated with at least one line of a chart, and meta information, which is information associated with meta data, as ground truth (GT), store an image formed using the GT as a chart image, and output the GT and the chart image as a data set;
input the chart image stored in the data set into an artificial intelligence (AI) model and, by the AI model, output a data format in which information of the chart is predicted, based on the input chart image; and
input the data format into a performance evaluation model and, by the performance evaluation model, output a performance evaluation result for the AI model by comparing information of the data format with the GT stored in the data set,
wherein a value applied to each parameter included in the line information and each parameter included in the meta information is selected from among predetermined values.
